(19) United States
(12) Patent Application Publication
(10) Pub. No.: US 2015/0000261 A1
(43) Pub. Date: Jan. 1, 2015

(54) Pressure Reduction of Gaseous Operating Media

(71) Applicant: HUCON Swiss AG, Rorschacherberg (CH)

(72) Inventor: Holger Uhl, Heubach (DE)

(21) Appl. No.: 14/361,254

(22) PCT Filed: Oct. 31, 2012
(86) PCT No.: PCT/EP2012/071616

§ 371 Date: May 28, 2014

(30) Foreign Application Priority Data
Nov. 29, 2011 (DE) 10 2011 055 841.1

(51) Int. Cl. F02C 1/00; F01K 17/04

(52) U.S. Cl. CPC F02C 1/00; F01K 17/04
USPC 60/327; 60/676; 60/407

(57) ABSTRACT

There are described an apparatus, a system and a method for the reduction of a pressure of a gaseous operating medium by expansion means which are arranged parallel with pressure reduction means, a portion of the gaseous operating medium being directed through the expansion means, the expansion means being configured to transform at least a portion of the energy released during the pressure reduction into mechanical energy by expansion of the gaseous operating medium, and for the transformation of at least a portion of the energy released during the pressure reduction into mechanical energy by the expansion means during the expansion of the portion of the gaseous operating medium which is directed through the expansion means.

### CROSS REFERENCE TO RELATED APPLICATIONS

This application is a National Phase application of International Patent Application No. PCT/EP2012/071616, filed Oct. 31, 2012, which claims the benefit of and priority to German Patent Application No. DE 10 2011 055 841.1, filed Nov. 29, 2011, which are both owned by the assignee of the instant application and the disclosures of which are incorporated herein by reference in their entireties.

### FIELD OF THE INVENTION

The subject-matter relates to a method, an apparatus and a method for pressure reduction of gaseous operating media with associated generation of mechanical energy.

### BACKGROUND OF THE INVENTION

The energy change decided upon in 2011 by the Federal German Government is determined by two significant objectives: firstly, the replacement of fossil energies by renewable energy is intended to be brought about and, secondly, an improvement of the energy efficiency in the case of transformation processes is intended to be brought about.

In order to improve the energy efficiency, in particular the law for promoting combined heat and power (KWK-Gesetz/CHP law) was passed. The CHP law provides for inter alia a minimum level of use of the primary energy used as coupled network energies heat and electrical power.

### SUMMARY OF THE INVENTION

On that basis, an object of the invention was to provide improved energy efficiency for networks having gaseous operating media such as, for example, a steam network.

This object is achieved in terms of subject-matter according to a first aspect of the invention by a method comprising the reduction of a pressure of a gaseous operating medium by expansion means which are arranged parallel with pressure reduction means, a portion of the gaseous operating medium being directed through the expansion means, the expansion means being configured to transform at least a portion of the energy released during the pressure reduction into mechanical energy by expansion of the gaseous operating medium, and comprising the transformation of at least a portion of the energy released during the pressure reduction into mechanical energy by the expansion means during the expansion of the portion of the gaseous operating medium which is directed through the expansion means.

This object is achieved in terms of subject-matter according to a second aspect of the invention by an apparatus comprising pressure reduction means, expansion means which are arranged parallel with the pressure reduction means, the pressure reduction means and the expansion means being configured to reduce a pressure of a gaseous operating medium, wherein a portion of the gaseous operating medium is directed through the expansion means, and wherein the expansion means are configured to transform at least a portion of the energy released during the pressure reduction into mechanical energy by expansion of the gaseous operating medium.

This object is achieved in terms of subject-matter according to a third aspect of the invention by a system comprising a network for distributing a gaseous operating medium, operating medium provision means which are connected to the network and which are configured to supply a gaseous operating medium having a specific pressure level to the network, and an apparatus according to the second aspect of the invention which is arranged in the network in such a manner that at least a portion of the gaseous operating medium supplied to the network by the operating medium provision means is directed into the apparatus at an input side, the apparatus being configured to output the gaseous operating medium supplied at the input side with reduced pressure at the output side.

For example, the apparatus may comprise means for distributing the gaseous operating medium which are connected to the expansion means and the pressure reduction means. Those means for distributing the gaseous operating medium are configured to direct the portion of the gaseous operating medium to the expansion means that is expanded by the expansion means. That portion may be 100% of the gaseous operating medium supplied to the means for distributing the gaseous operating medium, in that case the means for distributing the gaseous operating medium not supplying a gaseous operating medium to the pressure reduction means and the total portion of the gaseous operating medium being supplied to the expansion means. In this case, the expansion means may be considered to be, for example, a bypass with respect to the pressure reduction means, wherein the expansion means are arranged parallel with the pressure reduction means in such a manner that the complete gaseous operating medium can be directed past the pressure reduction means and through the expansion means. Thus, for example, in an existing installation, an available pressure reduction means such as, for example, a pressure reduction valve, can be completely bypassed by the expansion means which can be, for example, retrofitted so that the expansion means can perform, for example, an identical or similar pressure reduction objective to the one which was previously performed by the pressure reduction means. The pressure reduction means further remain configured to reduce a pressure. For instance, the pressure reduction means can be actuated, for example, in the event of a failure of the expansion means and can bring about the necessary pressure decrease, in this case of failure the means for distribution being able to switch the gaseous operating medium, for example, in such a manner that the gaseous operating medium is directed via the pressure reduction means, for example, completely or predominantly.

According to an advantageous embodiment, it is proposed that a further portion of the gaseous operating medium is directed through the pressure reduction means. The means for distributing the gaseous operating medium can also be configured, for example, to supply a portion of the gaseous operating medium to the expansion means, that portion being able to be from a value greater than 0% up to a value smaller than 100% of the total portion of the gaseous operating medium supplied to the means for distribution so that this portion of the gaseous operating medium represents the portion of the gaseous operating medium that is directed through the expansion means, and wherein the distribution means at the same time are configured to direct a further portion of the gaseous operating media through the pressure reduction means. In this case, the expansion means may be considered to be, for example, a bypass which is arranged parallel with the pressure reduction means, the portion of the gaseous operating medium directed through the expansion means representing a sub-quantity of the gaseous operating medium which is supplied to the distribution means. Thus, both the pressure reduction means and the expansion means take up a contribution to the pressure reduction of the gaseous operating medium in this case.

The means for distributing the gaseous operating medium can also separate from the gaseous operating medium, for example, one or more other portions in addition to the portion that is directed through the expansion means and the further portion.

The operating medium provision means are accordingly adapted to the gaseous operating medium selected. If the gaseous operating medium is, for example, steam, the operating medium provision means may be a steam generator such as, for example, a steam boiler. However, the operating medium provision means may also be, for example, a biomass gas generator or a compressed air generator or any other operating medium provision means which provides the gaseous operating medium.

The gaseous operating medium may be, for example, a steam-like operating medium, for example, for a steam network, or a gaseous operating medium for a carbon dioxide network or an operating medium substantially comprising air for compressed air networks or, for example, an operating medium containing natural gas for natural gas networks or, for example, nitrogen for nitrogen networks.

Furthermore, the pressure range of the gaseous operating media may be in the low pressure range, for example, in the pressure range between 1 bar and 10 bar, in particular in the pressure range up to 5 bar or in the pressure range up to 3 bar. However, the pressure range of the gaseous operating media may also be different therefrom.

The pressure reduction means are configured to reduce the pressure of a further portion of the gaseous operating medium supplied at the input side and to output at the output side a corresponding pressure-reduced first portion of the gaseous operating medium if the pressure reduction means are not completely bypassed by the expansion means.

The expansion means are configured to reduce the pressure of the portion of the gaseous operating medium supplied to the expansion means at the input side and to output at the output side a corresponding pressure-reduced portion of the gaseous operating medium.

The expansion means are further configured to transform at least a portion of the energy released during the pressure reduction into mechanical energy by expanding the gaseous operating medium. That expansion may be brought about by expansion of the gaseous operating medium such as, for example, by an inversely operated compressor. The transformed mechanical energy can be output, for example, at an output, for example, via a shaft or a chain or the like.

The expansion means are configured to generate mechanical work during the pressure reduction. Thus, the expansion means are configured, for example, to transform at least a portion of an exergy of that first portion of the gaseous operating medium into anergy during the expansion of the portion of the gaseous operating medium supplied at the input side, whereby an expansion is brought about with associated generation of work output. That transformation of an exergy into an anergy may be brought about, for example, by reducing a temperature level of the second portion of the gaseous operating medium during the expansion by the expansion means, thermal energy being transformed into mechanical energy. Accordingly, the output-side portion of the gaseous operating medium may have a lower temperature level than the input-side portion of the gaseous operating medium. Therefore, the expansion means may be considered to be combined heat and power means (CHP).

Thus, at least a portion of the exergy of the gaseous operating medium can be transformed into a mechanical energy with the expansion means of the apparatus.

According to an advantageous embodiment, it is proposed that the pressure reduction means is not configured to generate mechanical work.

For example, the pressure reduction means may be configured in such a manner that the temperature level of the further portion of the gaseous operating medium that is optionally supplied at the input side remains substantially unchanged during the pressure reduction by the pressure reduction means so that the further portion of the gaseous operating medium which has reduced pressure and which is output at the output side by the pressure reduction means has substantially an identical or similar temperature level to the further portion of the gaseous operating medium supplied at the input side. Thus, the pressure reduction means may be configured, for example, to bring about the pressure reduction without generating a work output.

According to an advantageous embodiment, it is proposed that the pressure reduction means represents at least one pressure reduction valve.

According to an advantageous embodiment, it is proposed that the mechanical energy transformed by the expansion means is transformed into electrical energy.

The expansion means may also comprise energy transformation means which are configured to transform the mechanical energy transformed by the expansion means into electrical energy. The optional output may be an output for outputting the transformed electrical energy in this example. For example, that energy transformation means may comprise a generator which is driven with the mechanical energy and which transforms the mechanical energy into electrical energy.

According to an advantageous embodiment, it is proposed that the expansion carried out by the expansion means in respect of the portion of the operating medium that is directed through the expansion means follow a linearly directed expansion process.

The pressure-reduced portion of the gaseous operating medium output at the output side by the expansion means is not supplied to the input of the expansion means in an arbitrary form in this linearly orientated expansion process, as would be the case in a cyclical process.

According to an advantageous embodiment, it is proposed that the expansion means is a counter-pressure apparatus.

In a counter-pressure apparatus, the pressure level of the pressure present at the output side is, for example, higher than the ambient pressure of the apparatus such as, for example, the normal pressure, that is to say, for example, greater than approximately 1013.25 mbar.

According to an advantageous embodiment, it is proposed that the gaseous operating medium represents a steam-like operating medium and that the transformation of at least a portion of the energy released during the pressure reduction into mechanical energy by the expansion means comprise the transformation of at least a portion of a steam exergy of the portion of the gaseous operating medium, which is directed through the expansion means, into steam anergy.

According to an advantageous embodiment, it is proposed that the transformation of at least a portion of the energy released during the pressure reduction into mechanical energy by the expansion means is carried out by transforming thermal energy into mechanical energy.

According to an advantageous embodiment, it is proposed that only so much steam exergy of the portion of the steam-like operating medium that is directed through the expansion means is transformed into steam anergy that the temperature of the portion of the operating medium that is expanded by the expansion means is sufficient for a subsequent heating application.

For example, the expansion means may be configured in such a manner that only so much exergy of the portion of the steam-like operating medium that is directed through the expansion means is transformed into anergy that the temperature of the portion of the operating medium that is expanded by the expansion means is sufficient for a subsequent heating application in a sink which is connected to the apparatus. For example, this sink requires a specific minimum temperature for ensuring the functionality of the sink. If the gaseous operating media supplied to the apparatus has a higher temperature than that minimum temperature of the sink, for example, the expansion means may be configured in such a manner that the temperature of the pressure-reduced gaseous portion of the operating medium at the output of the expansion means is reduced in terms of temperature relative to the temperature of the portion of the gaseous operating medium supplied at the input side so that the temperature of the combined, pressure-reduced gaseous operating medium substantially corresponds to the minimum temperature of the sink or is above the minimum temperature of the sink.

Thus, for example, it may be ensured, on the one hand, that the sink is supplied with a gaseous operating medium having an adequate minimum temperature, it simultaneously being possible to reduce the pressure of the gaseous operating medium by means of the apparatus to a pressure level which is adapted to the sink and, on the other hand, heat which is not required for the functionality of the sink from the gaseous operating medium supplied to the apparatus can simultaneously be transformed at least partially into mechanical energy by the expansion means of the apparatus.

It is thereby possible to obtain mechanical energy from the gaseous operating medium supplied to the apparatus without the functionality of the sink being impaired and without further fuel being required.

According to an advantageous embodiment, it is proposed that the further portion of the operating medium, which may be pressure-reduced by the pressure reduction means, and the portion of the operating medium that is pressure-reduced by the expansion means be combined to form a pressure-reduced operating medium. This may particularly apply if a portion of the gaseous operating medium is also directed through the pressure reduction means so that, after the pressure reduction by the expansion means and the pressure reduction means, the pressure-reduced portions of the gaseous operating medium are combined before they are further directed, for example, to a sink.

According to an advantageous embodiment, it is proposed that the expansion means comprise at least one of the following apparatuses: steam piston type motor, steam screw type motor, rolling piston type motor, roots blower and scroll motor.

According to an advantageous embodiment, it is proposed that the gaseous operating medium be a constituent of a low pressure system.

According to an advantageous embodiment, it is proposed that the method be applied in one of the following networks: steam network, carbon dioxide network, compressed air network, nitrogen network and natural gas network.

According to an advantageous embodiment, it is proposed that the system comprise at least one sink for gaseous operating medium, the apparatus being connected at the output side to at least one sink of the at least one sink(s).

The network may comprise, for example, pipes for further conveying the gaseous operating medium and may have, for example, at least one means for dividing gaseous operating medium into at least two portions.

For example, this at least one sink requires a specific minimum temperature of the gaseous operating medium supplied by the apparatus in order to ensure the functionality thereof.

If the system comprises a plurality of sinks, for example, a respective apparatus can be associated according to the second aspect of the invention with a sink of at least two sinks of the plurality of sinks in such a manner that the respective apparatus conveys a gaseous operating medium provided by the operating provision means in a state having reduced pressure to the sink associated with the apparatus, respectively.

For example, the gaseous operating media provided by the operating medium provision means may have an output pressure level of such a magnitude and/or the provided output temperature level such that this gaseous operating medium, after supply via the network to the sink that has the highest minimum pressure level and/or the highest minimum temperature level of the at least one sink(s), complies with the minimum pressure level and/or the minimum temperature level of that sink as an input operating medium for that sink.

For example, the minimum temperature level of a first sink may below the output temperature level of the gaseous operating media produced by the operating medium provision means. Furthermore, the desired pressure level of the first sink is below the output pressure level of the gaseous operating media produced by the operating medium provision means.

The system comprises a first apparatus according to the second aspect of the invention which is arranged between the first sink and the operating medium provision means so that at least a portion of the gaseous operating medium supplied to the network by the operating medium provision means is directed at the input side into the first apparatus as a gaseous operating medium, the first apparatus being configured to output at the output side the gaseous operating medium supplied at the input side as a pressure-reduced gaseous operating medium which is further directed to the first sink. In this case, the pressure level of that pressure-reduced gaseous operating medium may correspond to the desired pressure level of the first sink. At the same time, the expansion means of the first apparatus transform at least a portion of the energy released during the pressure reduction into mechanical energy.

Since the minimum temperature level required by the first sink is below the output temperature level, and is thus below the temperature level of the gaseous operating medium supplied at the input side to the first apparatus, the expansion means of the first apparatus can be configured, for example, in such a manner that only so much exergy of the second portion of the gaseous operating medium is transformed into anergy that the temperature of the second portion of the operating medium that is expanded by the expansion means is sufficient for a subsequent heating application in the first sink which is connected to the first apparatus. For example, the expansion means may be configured in such a manner that the temperature of the pressure-reduced gaseous portion of the operating medium that is directed through the expansion means is decreased at the output of the expansion means in terms of temperature in relation to the temperature of the portion of the gaseous operating medium supplied at the input side so that the temperature of the combined, pressure-reduced, gaseous operating medium which is output by the first apparatus substantially corresponds to the minimum temperature of the first sink or is higher than the minimum temperature of the first sink. If, for example, the means for distributing the gaseous operating medium are configured in such a manner that the gaseous operating media are directed completely or almost completely via the expansion means, the combined pressure-reduced, gaseous operating medium at the output of the first apparatus represents the pressure-reduced portion of the gaseous operating medium output by the expansion means because no gaseous operating medium is directed through the pressure reduction means.

Thus, the thermal energy of the steam that is not needed at all by the sink in order to maintain the functionality thereof can be transformed at least partially into mechanical energy by the expansion means.

For example, such an adapted apparatus according to the second aspect of the invention which transforms thermal energy of the supplied gaseous operating medium not needed for the respective sink at least partially into mechanical energy by the expansion means of the apparatus 110,110′ may be provided for each sink of at least two sinks of the system whose minimum temperature is below the output temperature level of the gaseous operating medium supplied to the network by operating medium provision means.

The energy efficiency in the network can thereby be increased, mechanical energy and therefrom, for example, also electrical energy from the pressure reduction being able to be generated by the at least one apparatus according to the second aspect of the invention without further fuels being required.

The network may also comprise an further sink which is connected to the operating medium provision means without an apparatus according to the second aspect of the invention being connected between the further sink and the operating medium provision means.

The operating medium provision means may, for example, be dimensioned and/or controlled in such a manner that the gaseous operating medium produced has such a high output temperature that the sink of the plurality of sinks that has the highest minimum temperature level of the sinks is also supplied with gaseous operating media having a temperature level which is adequate for this sink via the network. This sink may, for example, represent the further sink.

Thus, the operating medium provision means in the system may be configured in such a manner that the sink having the highest minimum temperature level is also supplied with gaseous operating medium having an adequate temperature level whilst an apparatus according to the second aspect of the invention can be associated with at least one other sink of the plurality of sinks in such a manner that at least a portion of the gaseous operating medium supplied to the network by the operating medium provision means is provided for the apparatus at the input side as a gaseous operating medium, respectively, the apparatus being configured to output at the output side the gaseous operating medium supplied at the input side as a pressure-reduced gaseous operating medium which is further conveyed to the sink, respectively, the expansion means of the apparatus simultaneously transforming at least a portion of the energy released during the pressure reduction into mechanical energy.

According to an advantageous embodiment, it is proposed that the network is a gas network.

According to an advantageous embodiment, it is proposed that the network is one of the following networks: steam network, carbon dioxide network, compressed air network, nitrogen network and natural gas network.

### BRIEF DESCRIPTION OF THE DRAWINGS

FIG. 1 shows an exemplary apparatus according to an embodiment;

FIG. 2 shows an exemplary method according to an embodiment; and

FIG. 3 shows an exemplary system according to an embodiment.

### DETAILED DESCRIPTION

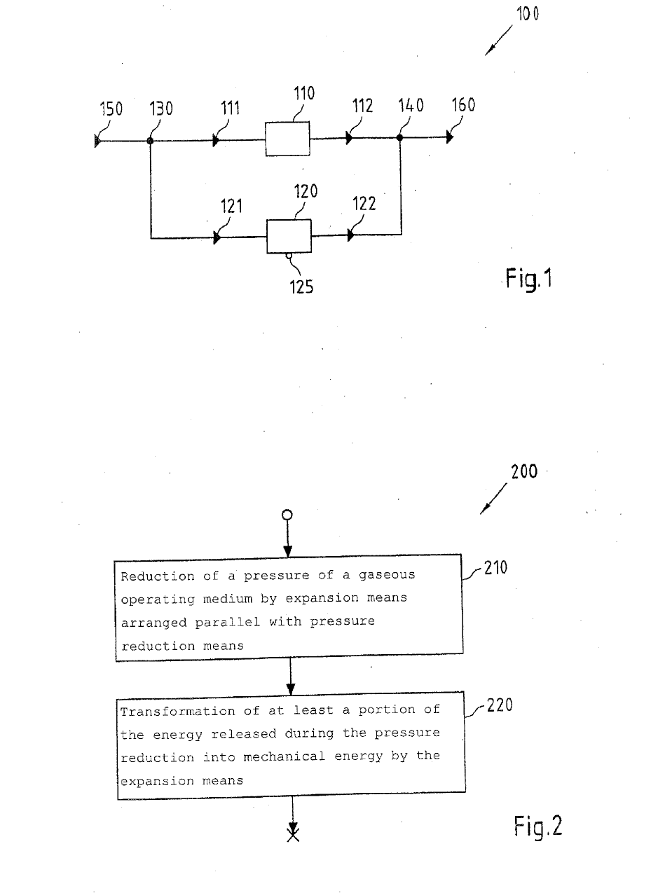

FIG. 1 shows an exemplary apparatus 100 according to an embodiment. This apparatus 100 is explained below together with the exemplary method 200 illustrated in FIG. 2 according to an embodiment.

The apparatus 100 comprises pressure reduction means 110 and expansion means 120, the expansion means 120 being arranged parallel with the pressure reduction means 110. The expansion means 120 arranged parallel with the pressure reduction means 110 are configured to reduce a pressure of a gaseous operating medium 150, as illustrated in step 210 of FIG. 2, a portion 121 of the gaseous operating medium 150 being directed through the expansion means 120 and optionally an further portion 111 of the gaseous operating medium 150 being directed through the pressure reduction means 110.

For example, the apparatus 100 may have means 130 for distributing the gaseous operating medium 150 which are connected to the expansion means 120 and the pressure reduction means 110. Those means 130 for distributing the gaseous operating medium 150 are configured to direct the portion 121 of the gaseous operating medium 150 to the expansion means, which portion is expanded by the expansion means. That portion 121 may be 100% of the gaseous operating medium 150 supplied to the means 130 for distributing the gaseous operating medium, in this case the means 130 for distributing the gaseous operating medium 150 not supplying any gaseous operating medium to the pressure reduction means 110 and the total portion of the gaseous operating medium 150 being supplied to the expansion means 120. In this case, the expansion means 120 may be considered to be, for example, a bypass with respect to the pressure reduction means 110, the expansion means 120 being arranged parallel with the pressure reduction means 110 in such a manner that the complete gaseous operating medium 150 can be directed past the pressure reduction means 110 and through the expansion means 120. Thus, for example, in an existing installation, an available pressure reduction means 110 such as, for example, a pressure reduction valve, can be completely bypassed by the expansion means 120, which can, for example, be retrofitted, so that the expansion means 120 can perform, for example, an identical or similar pressure reduction function to the one which was previously performed by the pressure reduction means 110. The pressure reduction means 110 further remain configured to reduce a pressure. For instance, the pressure reduction means 110 can be actuated, for example, in the event of a failure of the expansion means 120 and bring about the necessary decrease in pressure, in the event of this failure the means 130 for distribution being able to switch the gaseous operating medium 150, for example, in such a manner that the gaseous operating medium 150 is directed, for example, completely or predominantly via the pressure reduction means 110.

However, the means 130 for distributing the gaseous operating medium may also be configured, for example, to supply a portion 121 of the gaseous operating medium 150 to the expansion means 110, that portion 121 being able to be a value greater than 0% up to a value less than 100% of the total portion of the gaseous operating medium 150 supplied to the means for distribution so that this portion 121 of the gaseous operating medium 150 represents the portion 121 of the gaseous operating medium that is directed through the expansion means, and the means 130 for distribution simultaneously being configured to direct a further portion 111 of the gaseous operating medium 150 through the pressure reduction means 110. In this case, the expansion means 120 may be considered to be, for example, a bypass which is arranged parallel with the pressure reduction means 110, the portion 121 of the gaseous operating medium 150 directed through the expansion means 120 representing a sub-quantity of the gaseous operating medium 150 that is supplied to the means 130 for distribution. Thus, both the pressure reduction means 110 and the expansion means 120 take up a contribution to the pressure reduction of the gaseous operating medium in this case.

The means 130 for distributing the gaseous operating medium may also separate one or more other portions, for example, from the gaseous operating medium in addition to the portion 121 that is directed through the expansion means 120 and the further portion 111 (not illustrated in FIG. 1).

The gaseous operating medium 150 may represent, for example, a steam-like operating medium, for example, for a steam network, or a gaseous operating medium for a carbon dioxide network or an operating medium substantially comprising air for compressed air networks or, for example, an operating medium containing natural gas for natural gas networks or nitrogen for nitrogen networks.

The pressure range of the gaseous operating medium 150 may further be in the low pressure range, for example, in the pressure range between 1 bar and 10 bar, in particular in the pressure range up to 5 bar or in the pressure range up to 3 bar. However, the pressure range of the gaseous operating medium may also be different therefrom.

The pressure reduction means 110 are configured to reduce the pressure of the further portion 111 of the gaseous operating medium 150 which may be supplied at the input side and to output at the output side a corresponding, pressure-reduced further portion 112 of the gaseous operating medium 150.

The pressure reduction means 110 are not, for example, configured to generate mechanical work. For example, the pressure reduction means 110 may be configured in such a manner that the temperature level of the further portion 111 of the gaseous operating medium 150 supplied at the input side remains substantially unchanged during the pressure reduction by the pressure reduction means 110 so that the pressure-reduced further portion 112 of the gaseous operating medium 150 output at the output side by the pressure reduction means 110 substantially has an identical or similar temperature level to the further portion 111 of the gaseous operating medium 150 supplied at the input side. Thus, for example, the pressure reduction means 150 may be configured to carry out the pressure reduction without producing a work output. For example, the pressure reduction means 110 may comprise one or more pressure reduction valves.

The expansion means 120 are configured to reduce the pressure of the portion 121 of the gaseous operating medium 150 supplied at the input side and to output at the output side a corresponding pressure-reduced portion 122 of the gaseous operating medium 150.

The expansion means 120 are further configured to transform at least a portion of the energy released during the pressure reduction into mechanical energy by expansion of the gaseous operating medium, as illustrated in step 220 in FIG. 2. That mechanical energy may be output, for example, at the optional output 125, for example, via a shaft or a chain or the like. The expansion means 120 may also comprise energy transformation means (not shown in FIG. 1) which are configured to transform the mechanical energy which is transformed by the expansion means into electrical energy. For this example, the optional output 125 may be an output for outputting the transformed electrical energy. For example, those energy transformation means may comprise a generator which is driven with the mechanical energy and which transforms the mechanical energy into electrical energy.

Unlike the pressure reduction means 110, the expansion means 120 are configured to generate mechanical work during the pressure reduction. Thus, the expansion means 120 are configured, for example, to transform at least a portion of an exergy of this portion 121 of the gaseous operating medium 150 into anergy during the expansion of the portion 121 of the gaseous operating medium 150 supplied at the input side, whereby an expansion is carried out with associated generation of work output. This transformation of an exergy into an anergy may be carried out, for example, by reducing a temperature level of the portion 121 of the gaseous operating medium which is supplied to the expansion means 120 during the expansion by the expansion means 120, thermal energy being transformed into mechanical energy. Accordingly, the output-side portion 122 of the gaseous operating medium 150 of the expansion means 120 may have a lower temperature level than the input-side supplied portion 121 of the gaseous operating medium 150. Therefore, the expansion means 120 may be considered to be combined heat and power means (CHP).

Thus, at least a portion of the exergy of the gaseous operating medium 150 can be transformed into a mechanical energy with the expansion means 120 of the apparatus 100.

The apparatus 100 may comprise, for example, means 140 for combining the pressure-reduced first portion 112 of the gaseous operating medium 150 and the pressure-reduced second portion 122 of the gaseous operating medium 150 to form a combined pressure-reduced gaseous operating medium 160.

For example, the expansion means 120 may be configured in such a manner that only so much exergy of the portion 121 of the steam-like operating medium 150 that is supplied to the expansion means 120 is transformed into anergy that the temperature of the portion 122 of the operating medium 150 which is expanded by the expansion means is sufficient for a subsequent heating application in a sink 320 which is connected to the apparatus 110 (not shown in FIG. 1). For example, this sink 320 requires a specific minimum temperature in order to ensure the functionality of the sink 320. If the gaseous operating media 150 supplied to the apparatus 100 has a higher temperature than that minimum temperature of the sink 320, the expansion means 120 may be configured in such a manner, for example, that the temperature of the pressure-reduced gaseous portion 122 of the operating medium is reduced at the output of the expansion means 120 in terms of temperature relative to the temperature of the portion 121 of the gaseous operating medium 150 supplied at the input side so that the temperature of a combined, pressure-reduced, gaseous operating medium 160 substantially corresponds to the minimum temperature of the sink 320 or is above the minimum temperature of the sink 320.

Thus, for example, it may be ensured, on the one hand, that the sink 320 is supplied with a gaseous operating medium having an adequate minimum temperature, the pressure of the gaseous operating medium being able to be reduced simultaneously by the apparatus 100 to a pressure level adapted to the sink 320 and, on the other hand, heat which is not required for the functionality of the sink 320 from the gaseous operating medium 150 supplied to the apparatus 100 can simultaneously be transformed at least partially into mechanical energy by the expansion means 120 of the apparatus 100.

It is thereby possible to obtain mechanical energy from the gaseous operating medium supplied to the apparatus 100 without the functionality of the sink 320 being impaired and without further fuel being required. This mechanical energy can be transformed, for example, into electrical energy.

For example, the expansion means 120 may be configured as a counter-pressure apparatus. In a counter-pressure apparatus, the pressure level of the pressure present at the output side is, for example, greater than the ambient pressure of the apparatus 100 such as, for example, the normal pressure, that is to say, for example, greater than approximately 1013.25 mbar.

For example, the expansion means 120 may comprise at least one of the following apparatuses: a steam piston type motor, steam screw type motor, rolling piston type motor, roots blower and scroll motor.

The steam piston type motor may comprise, for example, one or more cylinders, there being associated with each cylinder a control piston which controls the necessary steam quantity by means of the travel of the piston. The piston(s) transmit(s) the force to a crankshaft which transmits the transformed mechanical energy.

The rolling piston type motor is, for example, a rotary motor which transforms thermal energy into rotation energy by the operating medium being expanded, and thus into mechanical energy. Thus, the rolling piston type motor may be a rolling piston compressor which is used to transform thermal energy into mechanical energy.

The scroll piston motor comprises, for example, two helixes which are fitted one inside the other and of which one is stationary and the other is moved via an eccentric power take-off over a circular path, the scroll piston motor representing a scroll compressor which is used to transform thermal energy into mechanical energy whilst the inversely operated scroll compressor expands the gaseous operating medium, that is to say, reduces the pressure.

The steam screw type motor may be, for example, a multiple-shaft rotary compression machine such as, for example, a screw compressor in which, for example, two helically toothed rotating shafts engage with each other and are closely surrounded by a housing. During the inlet operation, the steam can flow through a housing opening into a tooth space of the rotors arranged behind, the expansion operation being carried out with progressive rotation of the rotors owing to the increasing volume between the rotors.

For example, the gaseous operating medium 150 may be a steam-like operating medium. Thus, for example, the transformation of at least a portion of the energy released during the pressure reduction into mechanical energy by the expansion means 120 may comprise the transformation of at least a portion of a steam exergy of the second portion of the gaseous operating medium into steam anergy. In this case, the transformation of at least a portion of the energy released during the pressure reduction into mechanical energy by the expansion means may be carried out by transforming thermal energy into mechanical energy.

The apparatus 100 may further comprise, for example, other features which are not illustrated in FIG. 1. Thus, for example, apparatus 100 may comprise other pressure reduction means between the expansion means 120 and the optional means 140 for combining an optionally pressure-reduced further portion 112 of the gaseous operating medium 150 and the pressure-reduced portion 122 of the gaseous operating medium 150 which has been directed through the expansion means 120 to a combined, pressure-reduced, gaseous operating medium 160 and/or comprise pressure reduction means between the means 130 for dividing the gaseous operating medium 150 and the expansion means 120.

The advantages and embodiments of the apparatus 100 set out with reference to FIGS. 1 and 2 apply similarly to the apparatuses 100 and 100′ described below.

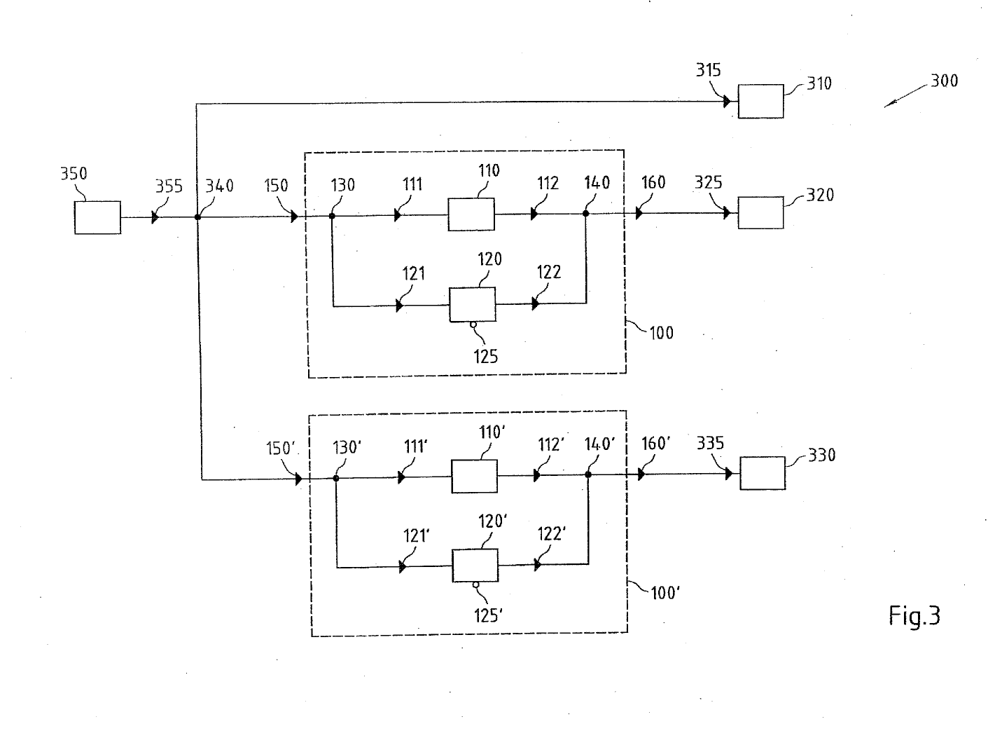

FIG. 3 shows an exemplary system 300 according to an embodiment.

This system 300 comprises a network for distributing a gaseous operating medium, operating medium provision means 350 which are connected to the network and which are configured to supply a gaseous operating medium 355 having a specific pressure level to the network and an apparatus 100 which corresponds to the exemplary apparatus 100 illustrated in FIG. 1 and which is arranged in the network in such a manner that at least a portion of the gaseous operating medium 355 supplied to the network by the operating medium provision means 350 is directed into the apparatus 100 at the input side 150, the apparatus 100 being configured to output the gaseous operating medium 150 supplied at the input side in a pressure-reduced state at the output side 160.

At the same time, the expansion means 120 of the apparatus 100 transforms at least a portion of the energy released during the pressure reduction into mechanical energy, as described above. This may be, for example, a linear expansion process in which the gaseous operating medium 150 flows from a higher pressure level in the direction of the gaseous operating medium 160 at the output side at lower pressure 160, the output-side operating medium 160 being consumed by the sink 320 and not being directed back to the expansion means 120. Instead, the output-side operating medium 160 is subsequently supplied by the operating medium provision means 350. Thus, the expansion means 120 may be considered to be, for example, a CHP means with heat supply.

The network may comprise, for example, pipes for conveying the gaseous operating medium and may have, for example, at least one optional means 340 for distributing gaseous operating medium in at least two portions. The system 300 may comprise at least one sink 310, 320, 330 which receives a supply of at least a portion of the gaseous operating medium via the network, respectively. However, the system may also comprise, for example, only precisely one sink 320. Furthermore, the system may comprise, for example, at least one further apparatus 100′ which may correspond, for example, to the exemplary apparatus 100 illustrated in FIG. 1.

The network may be, for example, a steam network, the gaseous operating medium 150 being able to be, for example, steam, or the network may be, for example, a carbon dioxide network, or the network may be, for example, a compressed air network, the gaseous operating medium 150 substantially comprising, for example, air, or the network may be, for example, a natural gas network.

It may be assumed below by way of non-limiting example that the network is a steam network and the gaseous operating medium 150 is steam.

The operating medium provision means 350 may be, for example, a steam generator 350 such as, for example, a steam boiler 350. That steam generator 350 may be configured, for example, to provide steam having a specific output pressure level and a specific output temperature level.

Each of the at least one sink(s) 310, 320, 330 may be configured, for example, to obtain a specific minimum pressure level and/or specific minimum temperature level in the form of input-side steam 315, 325, 335 in order to be able to be operated in a functional manner.

For example, the steam 355 provided by the steam generator 350 may have an output pressure level and/or an output temperature level of such a magnitude that this steam complies with the minimum pressure level and/or the minimum temperature level of that sink 310 in the form of input steam 315 for that sink 310 after being supplied via the network to the sink that has the highest minimum pressure level and/or the highest minimum temperature level of the at least one sink(s) 310, 320, 330.

The steam network may be, for example, a steam heating network, the first sink 320 being a steam heating system. The minimum temperature level of the first sink 320 is, for example, below the output temperature level of the steam produced by the steam generator 350. The desired pressure level of the first sink 320 is further below the output pressure level of the steam produced by the steam generator 350. The sink 320 may also be, for example, a steam heating system which requires steam 325 which is supplied at the input side and which has a specific minimum temperature.

The system 300 comprises the apparatus 100 which is arranged between the first sink 320 and the optional means 340 for dividing the steam 355 so that at least a portion of the gaseous operating medium supplied to the network by the operating medium provision means is directed as steam 150 into the apparatus 100 at the input side, the apparatus 100 being configured to output at the output side the gaseous operating medium supplied at the input side as a pressure-reduced steam 160 which is further conveyed to the first sink 320. In this case, the pressure level of the pressure-reduced steam may correspond to the desired pressure level of the first sink 320. At the same time, the expansion means 120 of the apparatus 100 transforms at least a portion of the energy released during the pressure reduction into mechanical energy.

Since the minimum temperature level required by the first sink 320 is below the output temperature level of the steam 355 and thus below the temperature level of the steam 150 supplied at the input side of the apparatus 100, for example, the expansion means 120 of the apparatus 100 may be configured in such a manner that only so much exergy of the second portion 121 of the steam-like operating medium 150 is transformed into anergy that the temperature of the portion 122 of the operating medium 150 which is expanded by the expansion means is adequate for a subsequent heating application in the first sink 320 connected to the apparatus 100. The expansion means 120 may be configured in such a manner, for example, that the temperature of the pressure-reduced gaseous portion 122 of the operating medium at the output of the expansion means 120 is reduced in terms of temperature relative to the temperature of the portion 121 of the gaseous operating medium 150 supplied at the input side so that the temperature of the combined, pressure-reduced, gaseous operating medium 160 substantially corresponds to the minimum temperature of the sink 320 or is above the minimum temperature of the sink 320. If, for example, the means 130 for distributing the gaseous operating medium 150 are configured in such a manner that the gaseous operating media are directed completely or almost completely via the expansion means 120, the combined, pressure-reduced, gaseous operating medium 160 at the output of the apparatus 100 represents the pressure-reduced portion 122 of the gaseous operating medium 150 output by the expansion means 120 because no gaseous operating medium 150 is directed through the pressure reduction means 110.

Thus, the thermal energy of the steam 150 which is not required at all by the sink 320 in order to maintain the functionality thereof may be transformed at least partially into mechanical energy by the expansion means 120.

The steam network may optionally comprise, for example, a second sink 310 which may also be a steam heating system which requires steam 315 which is supplied at the input side and which has a specific minimum temperature. It may be assumed that the minimum temperature of the second sink 310 is above the minimum temperature of the first sink 320.

The steam generator 350 must have dimensions or be controlled so that the steam produced has such a high output temperature that the steam 315 supplied to the sink 310 via the means 140 for dividing the steam has a temperature which substantially corresponds to the minimum temperature of the sink 310 or is above that minimum temperature. For example, steam pressure reduction means 110 as described with reference to FIG. 1 may also optionally be positioned between the means 140 for dividing the steam and the sink 310 in order to reduce a steam pressure.

Thus, the steam generator 350 must provide, for example, steam 355 whose output temperature level is higher than the minimum temperature level required by the first sink 320 because it is often unviable in technical system terms to provide for each sink 310, 320, 330 a specially adapted steam generator having an adapted output temperature level, respectively.

The apparatus 100 according to the invention allows at least a portion of the thermal energy of that high output temperature level of the steam provided by the steam generator 355 to be used and to be transformed into mechanical energy without the functionality of the first sink 320 connected to that apparatus 100 being impaired. Thus, mechanical energy may be obtained in that heating steam network and also, for example, electrical energy therefrom, without further fuel being required and without the functionality of the sinks 310, 320, 330 being impaired.

Furthermore, the steam network may also comprise further sinks, only a third sink 330 being illustrated in FIG. 3 by way of example. If one of those further sinks 330 requires a minimum temperature level which is below the output temperature level of the steam 355, there may be provided for that third sink 330 an further apparatus 100′ which is positioned between the third sink 330 and the steam generator 350 and which reduces a portion 150′ of the steam 355 of the steam generator 350 both in terms of the pressure level in accordance with the desired pressure level of the third sink 330 and in terms of the temperature level in accordance with the minimum temperature level of the third sink 330. The expansion means 120′ of the apparatus 100′ may also be configured, similarly to the expansion means 120 of the apparatus 100, so that only as much exergy of the portion 121′ of the steam 150′ which is directed through the expansion means 120′ is transformed into anergy that the temperature of the portion 122′ of the steam 150′ which is expanded by the expansion means 120′ is sufficient for the subsequent heating application in the third sink 330 connected to the apparatus 110′.

Thus, for example, there may be provided, for each sink 320, 330 whose minimum temperature is below the output temperature of the steam 355, a suitably adapted apparatus 100, 100′ which transforms at least a portion from the thermal energy of the supplied steam 150, 150′ not required for the sink 320, 330 into mechanical energy by expansion means 120, 120′ of the apparatus 110, 110′, respectively.

The energy efficiency in steam systems can thereby be increased, mechanical energy being able to be obtained and also, for example, electrical energy therefrom, from the pressure reduction owing to the apparatus 100, 100′ without further fuels being required.

1. A method comprising:
reduction of a pressure of a gaseous operating medium by expansion means which are arranged parallel with pressure reduction means, wherein a portion of the gaseous operating medium is directed through the expansion means, wherein the expansion means are configured to transform at least a portion of the energy released during the pressure reduction into mechanical energy by expansion of the gaseous operating medium, and
transformation of at least a portion of the energy released during the pressure reduction into mechanical energy by the expansion means during the expansion of the portion of the gaseous operating medium which is directed through the expansion means.

2. The method according to claim 1, characterised in that a further portion of the gaseous operating medium is directed through the pressure reduction means.

3. The method according to claim 1, characterised in that the pressure reduction means are not configured to generate mechanical work.

4. The method according to claim 1, characterised in that the pressure reduction means represents at least one pressure reduction valve.

5. The method according to claim 1, characterised in that the mechanical energy transformed by the expansion means is transformed into electrical energy.

6. The method according to claim 1, characterised in that the expansion carried out by the expansion means in respect of the portion of the gaseous operating medium which is directed through the expansion means follows a linearly directed expansion process.

7. The method according to claim 1, characterised in that the expansion means is a counter-pressure apparatus.

8. The method according to claim 1, characterised in that the gaseous operating medium represents a steam-like operating medium and in that the transformation of at least a portion of the energy released during the pressure reduction into mechanical energy by the expansion means comprises the transformation of at least a portion of a steam exergy of the portion of the gaseous operating medium, which is directed through the expansion means, into steam anergy.

9. The method according to claim 1, characterised in that the transformation of at least a portion of the energy released during the pressure reduction into mechanical energy by the expansion means is carried out by transforming thermal energy into mechanical energy.

10. The method according to claim 8, characterised in that only so much steam exergy of the portion of the steam-like operating medium that is directed through the expansion means is transformed into steam anergy that the temperature of the portion of the operating medium that is expanded by the expansion means is sufficient for a subsequent heating application.

11. The method according to claim 1, characterised in that the further portion of the operating medium, which is pressure-reduced by the pressure reduction means, and the portion of the operating medium that is pressure-reduced by the expansion means are combined to form a pressure-reduced operating medium.

12. The method according to claim 1, characterised in that the expansion means comprise at least one of the following apparatuses:
steam piston type motor,
steam screw type motor,
rolling piston type motor,
roots blower and
scroll motor.

13. The method according to claim 1, characterised in that the gaseous operating medium is a constituent of a low pressure system.

14. The method according to claim 1, characterised in that the method is applied in one of the following networks:
steam network,
carbon dioxide network,
compressed air network, and
natural gas network.

15. An apparatus comprising:
pressure reduction means,
expansion means which are arranged parallel with the pressure reduction means,
the pressure reduction means and the expansion means being configured to reduce a pressure of a gaseous operating medium, a portion of the gaseous operating medium being directed through the expansion means, and
the expansion means being configured to transform at least a portion of the energy released during the pressure reduction into mechanical energy by expanding of the gaseous operating medium.

16. The apparatus according to claim 15, characterised in that a further portion of the gaseous operating medium is directed through the pressure reduction means.

17. The apparatus according to claim 15, characterised in that the pressure reduction means are not configured to generate mechanical work.

18. The apparatus according to claim 15, characterised in that the pressure reduction means represents at least one pressure reduction valve.

19. The apparatus according to claim 15, characterised in that the apparatus comprises energy transformation means which are configured to transform the mechanical energy transformed by the expansion means into electrical energy.

20. The apparatus according to claim 15, characterised in that the expansion carried out by the expansion means in respect of the portion of the operating medium that is directed through the expansion means follows a linearly directed expansion process.

21. The apparatus according to claim 15, characterised in that the gaseous operating medium is a steam-like operating medium and that the transformation of at least a portion of the energy released during the pressure reduction into mechanical energy by the expansion means comprises the transformation of at least a portion of a steam exergy of the portion of the gaseous operating medium, which is directed through the expansion means, into steam anergy.

22. The apparatus according to claim 15, characterised in that the transformation of at least a portion of the energy released during the pressure reduction into mechanical energy by the expansion means is carried out by transforming thermal energy into mechanical energy.

23. The apparatus according to claim 16, characterised in that the further portion of the operating medium, which is pressure-reduced by the pressure reduction means, and the portion of the operating medium that is pressure-reduced by the expansion means are combined to form a pressure-reduced operating medium.

24. The apparatus according to claim 15, characterised in that the expansion means comprise at least one of the following apparatuses:
steam piston type motor,
steam screw type motor,
rolling piston type motor,
roots blower and
scroll motor.

25. The system comprising:
a network for distributing a gaseous operating medium,
operating medium provision means which are connected to the network and which are configured to supply a gaseous operating medium having a specific pressure level to the network,
an apparatus according to claim 15 which is arranged in the network in such a manner that at least a portion of the gaseous operating medium supplied to the network by the operating medium provision means is directed into the apparatus at the input side, the apparatus being configured to output the gaseous operating medium supplied at the input side with reduced pressure at the output side.

26. The system according to claim 25, characterised in that the system comprises at least one sink for gaseous operating medium, the apparatus being connected at the output side to at least one sink of the at least one sink.

27. The system according to claim 26, characterised in that the gaseous operating medium is a steam-like operating medium, and that the transformation of at least a portion of the energy released during the pressure reduction into mechanical energy by the expansion means comprises the transformation of at least a portion of a steam exergy of the portion of the gaseous operating medium that is directed through the expansion means into steam anergy, and the expansion means being configured in such a manner that only so much steam exergy of the portion of the steam-like operating medium which is directed through the expansion means is transformed into steam anergy that the temperature of the portion of the operating medium that is expanded by the expansion means and thus the temperature of the pressure-reduced, steam-like operating medium output at the output side by the apparatus is sufficient for a subsequent heating application in the sink connected to the apparatus.

28. The system according to claim 25, characterised in that the network is one of the following networks:
steam network,
carbon dioxide network,
compressed air network, and
natural gas network.
